(19) United States
(12) Patent Application Publication
(10) Pub. No.: US 2024/0149625 A1
(43) Pub. Date: May 9, 2024

(54) Equipment For An Electronic System for Checking The Pressure of the Tyres Of A Motor Vehicle

(71) Applicant: ATEQ, Les Clayes Sous Bois (FR)

(72) Inventor: Jacques Mouchet, Singapore (SG)

(21) Appl. No.: 18/576,281

(22) PCT Filed: Jun. 29, 2022
(86) PCT No.: PCT/EP2022/067952

§ 371 Date: Jan. 3, 2024

(30) Foreign Application Priority Data
Jul. 6, 2021 (FR) FR2107290

(51) Int. Cl. B60C 23/04

(52) U.S. Cl. CPC B60C 23/0479; B60C 23/0447; B60C 23/0471

(57) ABSTRACT

Electronic equipment for use in checking the air pressure of the tires of a motor vehicle and communicating information to an on-board computer of the motor vehicle is disclosed. The equipment includes a device including an internal pressure sensor and a connection means for connecting the device to a valve of a tire to place the internal pressure sensor in communication with the internal air pressure of the tire. In one example, the electronic equipment includes a device having a first case, and the internal air pressure sensor is in a separate second case including the connection means to connect the second case to the valve of the tire. The internal air pressure sensor in the second case is configured to be in communication with the components in the first case of the device.

### CROSS-REFERENCE TO RELATED APPLICATIONS

This application is filed pursuant to 35 U.S.C. § 371 claiming priority benefit to PCT/EP2022/067952 filed Jun. 29, 2022, which claims priority benefit to French Patent Application No. 2107290 filed Jul. 6, 2021, the contents of both applications are incorporated herein by reference in the entirety for all purposes.

### TECHNICAL FIELD

The present invention relates to the field of tyre pressure monitoring systems (the usual acronym of which is TPMS) of motor vehicles.

### BACKGROUND

Indeed, in such systems, the pressure sensors are generally housed in the tyres (or tires) of the vehicle and associated to the on-board computer of the motor vehicle to which said sensors transmit data. The sensor-on-board assembly is thus designated under the term “tyre pressure monitoring system”.

Indeed, each pressure sensor is conventionally equipped with a radio frequency transmitter to make it possible to transmit data to the on-board computer. The on-board computer receiving data from the sensors may thus alert the user of the vehicle if one of the tyres were to puncture or deflate, resulting in a risk for their safety. It will also be noted that the pressure sensors may also be equipped with a communication means of the Bluetooth, and more particularly BLE (Bluetooth Low Energy) type, instead of or in addition to another radio frequency transmission means.

However, the pressure sensor associated with the wheel (generally housed inside of it) is not always removable. Thus, changing a wheel implies changing the sensor, the new sensor then no longer being detected or recognized by the on-board computer of the vehicle.

It is therefore necessary, when changing the tyres, to pair (or associate) the sensors housed inside the new tyres with the on-board computer of the vehicle.

This pairing is carried out by means of a dedicated device or apparatus (generally designated under the term “TPMS tool”), this device being configured to activate the pressure sensors, recover and record the relevant data emitted by the sensor, such as the identifier of the sensor, and transmit them, for example by way of an OBD cable, to the on-board computer, so that the latter can detect, and locate the sensors housed inside the newly installed tyres and receive therein the data, in order to warn the user in the event of a pressure drop in one of said tyres.

However, new needs have appeared during the use of such apparatus whether in a garage or also on a line for producing tyres or motor vehicles.

Indeed, it is possible that the motor vehicles do not comprise tyre pressure monitoring systems, and therefore no pressure sensors housed inside the tyres.

Thus, it may be necessary to rapidly measure the pressure of a tyre and to have a suitable apparatus for that.

It may also be necessary to be able to check the pressure of a tyre already housing a pressure sensor, particularly to check that the sensor is working correctly, is correctly positioned, has not drifted, and/or to check that it is not necessary to calibrate it or carry out any maintenance.

### SUMMARY

More particularly, the present invention relates to a device or apparatus making it possible to communicate over various frequencies, to program, and/or to pair one or more elements together, such as the tyre pressure sensors with the on-board computer of a vehicle, of said tyre pressure monitoring systems (it will be noted that said device is sometimes called “TPMS valve forcer”).

Thus, the present invention is an apparatus for an electronic system for monitoring the pressure of the tyres of a motor vehicle, said apparatus comprising a device which comprises:
an activation module for activating pressure sensors housed in a tyre;
a reception means for receiving signals from the pressure sensors;
an electronic entity configured to store and/or process the data carried by the signals emitted by the sensors;
a communication means communicating with a remote electronic entity, such as the on-board computer of a motor vehicle, so as to transmit the data from the received signals;
characterized in that said apparatus comprises an internal pressure sensor and a connection means for connection to a tyre valve, said connection means being configured to connect said internal pressure sensor to the valve of a tyre.

Thus, the invention makes it possible to have a single item of apparatus, on the one hand, for measuring the pressure of a tyre equipped or not with a pressure sensor and, on the other hand, for pairing pressure sensors with the on-board computer of a motor vehicle. This simplifies the task of the operator who does not need to have several items of apparatus and need to learn how to use them, while reducing the costs.

Moreover, it will be noted that “internal pressure sensor” means a pressure sensor dedicated to the apparatus according to the invention, whether it is housed directly inside the device or elsewhere. However, said internal pressure sensor is configured to be in communication with said device of the apparatus according to the invention.

According to a possible feature, said device comprises a reception housing for said internal pressure sensor.

Said internal pressure sensor is for example housed directly inside the device, for example inside a dedicated housing (or a cavity). Said connection means for connection to a tyre valve being configured to connect the internal pressure sensor to the tyre of which it is sought to measure the pressure.

According to another possible feature, said internal pressure sensor is housed inside a case different from said device.

It is advantageous to be able to move the internal pressure sensor away from the device to facilitate the connection and the disconnection of the internal pressure sensor to/from the tyre of which it is sought to measure the pressure value.

According to another possible feature, said internal pressure sensor is integral with the walls of said case.

The fact of securing the internal pressure sensor to the case makes it possible to prevent any movement of the internal pressure sensor inside the case, thus limiting the risk of the sensor becoming damaged by impacts and/or the pressure measurement becoming altered.

According to another possible feature, said connection means is fixed to said case.

Said connection means makes it possible to establish, once that said connection means is connected to the valve of the tyre, an air path between the internal pressure sensor housed in the case and the interior of the tyre.

According to another possible feature, said case (housing the internal pressure sensor) and/or said device comprise mechanical and/or magnetic means for securing the device to the case. The operator may thus easily transport the assembly and separate them only at the time of their use.

According to another possible feature, said case comprises a material transparent to radio frequency waves. Advantageously, the internal pressure sensor comprises a wireless communication means for communicating with the device, for example by radio frequencies or by Bluetooth.

According to another possible feature, said case is made of plastic or polymers.

According to another possible feature, said connection means comprises a connector for a tyre valve.

According to another possible feature, said connection means comprises a tube making it possible to connect the connection means to the case and/or to connect the connection means to the valve of a tyre.

According to another possible feature, said internal pressure sensor of said apparatus is a pressure sensor for an electronic system for monitoring the pressure of the tyres of a motor vehicle. Advantageously, the internal pressure sensor used is a pressure sensor of the type of those housed inside the tyres of motor vehicles for the tyre pressure monitoring systems.

### BRIEF DESCRIPTION OF THE DRAWINGS

The invention will be better understood, and other aims, details, features and advantages thereof will become more apparent during the following description of particular embodiments of the invention, given purely by way of non-limiting example, with reference to the appended drawings, wherein:

FIG. 1, is a very schematic representation illustrating apparatus for activating pressure sensors of tyres according to the invention; and

FIG. 2, is an enlarged, partially cut-away front view of the device of FIG. 1.

### DETAILED DESCRIPTION

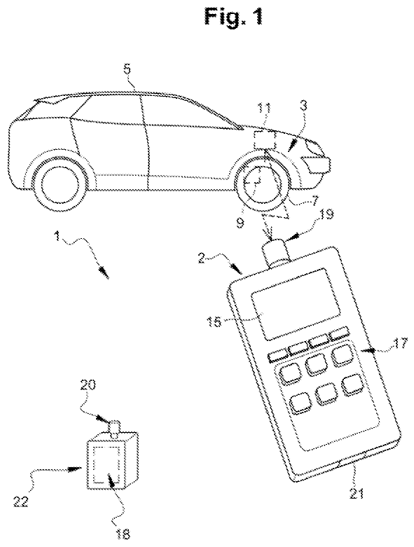

FIG. 1 is a very schematic representation of apparatus 1 for activating sensors 9, more particularly in the present example of activation apparatus 1 for an electronic system 3 for monitoring the pressure of the tyres of a motor vehicle 5 (said apparatus 1 also able to be designated or referred to under the terms “valve activator” or “valve forcer”).

The motor vehicle 5, on the one hand, is equipped with tyres 7 (or tires) in which the sensors 9, such as internal air pressure sensors, are housed, and on the other hand comprises an on-board computer 11 (also called electronic control unit and generally designated under the acronym “ECU”).

The apparatus 1 includes a device 2 which itself comprises a case 13 (known as first case), for example made of plastic, a display device 15, a keyboard 17 and an antenna 19 for emitting a sensor activation signal, as well as an OBD socket 21. Said OBD socket 21 is configured to make it possible for example to connect the device 2 (and therefore the apparatus 1) to the on-board computer 11 of a vehicle, particularly via an OBD cable.

Said apparatus 1 also comprises:
an internal pressure sensor 18, for example a pressure sensor for a motor vehicle tyre pressure monitoring system (also called “TPMS sensor”);
a connection means 20 for connection to a tyre valve, said connection means 20 being configured to connect said internal pressure sensor 18 to the valve of a tyre, particularly to enable the internal pressure sensor 18 to measure the air pressure prevailing inside the tyre.

Said apparatus 1 further comprises a case 22, known as second case, different from the case 13 (and therefore at a distance from the device 2), respectively the second case 22 and the first case 13.

Said second case 22 has an internal volume wherein said internal pressure sensor 18 is housed. Said connection means 20 is thus attached to the case 22 and makes it possible to connect the internal volume of said case 22, where the internal pressure sensor 18 is housed, to a motor vehicle tyre (particularly to enable the internal pressure sensor 18 to measure the pressure therein).

The second case 22 is thus made of a material transparent to radio frequency waves, so as to enable the internal pressure sensor 18 to wirelessly communicate with the device 2.

Said case 22 is for example made of a plastic or polymer material, the internal pressure sensor 18 being integral with the walls of the case 22, for example by overmoulding the case 22 on the internal pressure sensor 18.

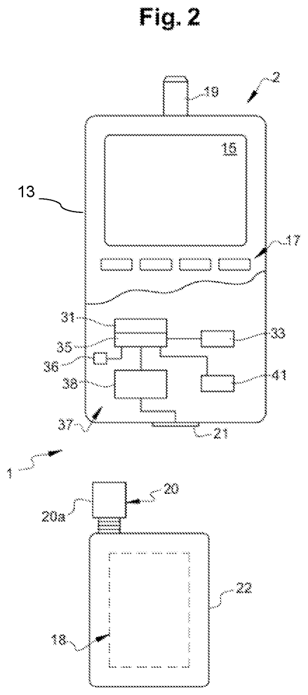

More particularly, said connection means 20 comprises a connector 20a for a tyre valve (more particularly shown in FIG. 2).

In an alternative embodiment not shown, said connection means 20 also comprises one or more tubes making it possible to connect the connector 20a to said case 22 and/or said connector 20a to the valve of the tyre.

In another alternative embodiment not shown, said second case 22 and/or said device 2 (particularly by means of the first case 13) comprise mechanical and/or magnetic means for securing the device 2 to the case 22. The mechanical and/or magnetic means are for example clips, magnets, of complementary shapes making it possible to lock the cases 13 and 22 to one another, etc.

FIG. 2, for its part, is an enlarged, partially cut-away and detailed front view of the apparatus 1 of FIG. 1.

Said device 2 thus comprises:
at least one sensor activation module 31, such as modules making it possible to generate signals (continuous and/or modulated) for activating sensors, said activation module 31 comprising the antenna 19 that particularly makes it possible to propagate as best as possible said generated signals up to the sensors 9 or 18;
a reception module 33 for receiving signals from the sensors, generally another antenna housed in the case 13 and configured for example to receive signals in a frequency band between 300 and 500 MHz (the sensor emitting a signal after having been activated by said activation module 31);
an electronic entity 35, such as a processor and a memory, configured to store and/or process the data carried by the signals emitted by said sensors 9 or 18 (and received by means of the reception module 33);
a communication means 37 communicating with the on-board computer 11 of the motor vehicle 5 for transmitting the data from at least one of said sensors 9 (data received by means of signals from said sensors 9).

The communication means 37 is for example an OBD module which comprises a managing circuit 38 for managing the OBD communication and the OBD socket 21 mentioned above. It will be noted that the management circuit 38 may also be integrated into the electronic entity 35.

It will be noted that OBD means all of the OBD modules complying with the OBD, OBD-II, E-OBD, J-OBD, etc., standards.

The device 2 also comprises a battery 41 configured to power the various elements mentioned above.

Moreover, the device 2 may also comprise an additional communication module 36 of the Bluetooth type, particularly of the “Bluetooth Low Energy” type, for communicating with the internal pressure sensor 18 disposed in the case 22 and/or with a pressure sensor 9 housed inside the tyre of the motor vehicle 5.

Moreover, it will be noted that said activation signals are continuous or modulated, electromagnetic signals, emitted by the activation module(s) 31, which have for example a frequency of 125 kHz.

In another alternative embodiment not shown, a cavity or a housing is arranged in the case 13 for housing the internal pressure sensor 18, the connection means 20 for connection to a tyre valve being attached on said case 13, in such a way as to enable, as above, said internal pressure sensor 18 to measure the pressure in a tyre of the motor vehicle 5.

Thus, the invention makes it possible to have a single item of apparatus for monitoring the pressure of motor vehicle tyres and/or for monitoring the correct operation of pressure sensors, already installed, of an electronic system for monitoring the pressure of the tyres of the motor vehicle 5.

1. An apparatus for an electronic system for monitoring air pressure of tyres of a motor vehicle, said apparatus comprising:
a device comprising:
an activation module for activating a pressure sensor housed in a tyre;
a reception means for receiving signals from the pressure sensor;
an electronic entity configured to at least one of store and/or process data carried by the signals received from the pressure sensor; and
a communication means configured to communicate with a remote electronic entity so as to transmit the data from the received signals;
an internal pressure sensor; and
a connection means for connection of the apparatus to a tyre valve of the tyre, said connection means being configured to connect said internal pressure sensor to the tyre valve of the tyre and operable to enable the internal pressure sensor to measure an air pressure of the tyre.

2. The apparatus according to claim 1, wherein said device further comprises a first case configured to house said internal pressure sensor.

3. The apparatus according to claim 1, wherein said internal pressure sensor is housed inside a second case distinct from said device.

4. The apparatus according to claim 3, wherein said internal pressure sensor is integral with a wall of said second case.

5. The apparatus according to claim 3, wherein said connection means is fixed to said second case.

6. The apparatus according to claim 3, wherein at least one of said second case or said device further comprises at least one of mechanical or magnetic means configured for securing the device to the second case.

7. The apparatus according to claim 3, wherein said second case comprises a material transparent to radio frequency waves.

8. The apparatus according to claim 7, wherein the material for said second case comprises a plastic or polymer material.

9. The apparatus according to claim 1, wherein said connection means comprises a connector configured to connect the apparatus to the tyre valve.

10. The apparatus according to claim 1, wherein said internal pressure sensor comprises a tyre air pressure sensor for a tire pressure monitoring system (TPMS) of the motor vehicle.

11. The apparatus according to claim 1, wherein the remote electronic entity comprises an on-board computer of the motor vehicle.

12. The apparatus according to claim 4, wherein said connection means is fixed to the second case.

13. The apparatus according to claim 5 wherein at least one of said second case or said device further comprises at least one of mechanical or magnetic means configured for securing the device to the second case.

14. The apparatus according to claim 5, wherein said connection means comprises a connector configured to connect the second case to the tyre valve.
